(19) United States
(12) Patent Application Publication
(10) Pub. No.: US 2026/0169760 A1
(43) Pub. Date: Jun. 18, 2026

(54) METHOD FOR LOADING EXECUTABLES INTO SPECIFIC TYPES OF SYSTEM MEMORY USING APPLICATION BINARY INTERFACE (ABI)-COMPLIANT NOTES

(71) Applicant: QUALCOMM Incorporated, San Diego, CA (US)

(72) Inventors: Amit KULKARNI, San Diego, CA (US); Amey MAHAJAN, San Diego, CA (US); Jeremy GILBERT, San Diego, CA (US)

(21) Appl. No.: 18/979,193

(22) Filed: Dec. 12, 2024

(51) Int. Cl. G06F 9/445

(52) U.S. Cl. CPC G06F 9/44521

(57) ABSTRACT

A method for loading an executable is described. The method includes identifying compiled code and data sections that map to a specific type of system memory. The method also includes grouping the identified code and data sections in individual executable and linkable format (ELF) segments in an ELF file. The method further includes embedding an encoded memory mapping scheme of each memory type of the compiled code and data sections in a notes section of the ELF file. The method also includes generating a program header table to identify the notes section of the ELF file.

### BACKGROUND

### Field

Aspects of the present disclosure relate to semiconductor devices and, more particularly, to a technique for loading executables into specific types of system memory using application binary interface (ABI)-compliant notes.

### Background

In general, a compiler is a computer software program that transforms high-level computer programming code, such as source code written in a human-readable language (e.g., C, C++), into a lower-level assembly or machine code (e.g., binary) executable image. For example, an executable image may be generated according to the executable and linkable format (ELF) standard binary file format supported on many different operating systems and platforms.

Executable images in ELF files include a memory map that outlines how the executable is loaded into a virtual address space. In practice, this metadata is utilized by a runtime ELF loader to read and map individual segments into memory before execution. Unfortunately, ELF metadata often falls short in specifying the physical memory placement of these segments. For example, runtime ELF loaders may use dynamic memory allocation to reserve and allocate physical memory. Moreover, setting up a fixed physical memory layout is not always practical. A technique for loading executables into specific types of system memory using application binary interface (ABI)-compliant notes, is desired.

### SUMMARY

A method for loading an executable is described. The method includes identifying compiled code and data sections that map to a specific type of system memory. The method also includes grouping the identified code and data sections in individual executable and linkable format (ELF) segments in an ELF file. The method further includes embedding an encoded memory mapping scheme of each memory type of the compiled code and data sections in a notes section of the ELF file. The method also includes generating a program header table to identify the notes section of the ELF file.

A non-transitory computer-readable medium having program code recorded thereon for loading an executable is described. The program code is executed by a processor. The non-transitory computer-readable medium includes program code to identify compiled code and data sections that map to a specific type of system memory. The non-transitory computer-readable medium also includes program code to group the identified code and data sections in individual executable and linkable format (ELF) segments in an ELF file. The non-transitory computer-readable medium further includes program code to embed an encoded memory mapping scheme of each memory type of the compiled code and data sections in a notes section of the ELF file. The non-transitory computer-readable medium also includes program code to generate a program header table to identify the notes section of the ELF file.

This has outlined, broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-chip (SoC), which is configured to support low power island modes, in accordance with various aspects of the present disclosure.

FIG. 2 is a circuit diagram further illustrating the system-on-chip (SoC) of FIG. 1, including low power island registers to support low power island modes, according to various aspects of the present disclosure.

FIG. 3 is a block diagram illustrating a compiler and linker process to support loading of executables into specific types of system memory using an application binary interface (ABI) format for ABI-compliant notes, according to various aspects of the present disclosure.

FIG. 4 is a block diagram illustrating an executable and linkable format (ELF) file to support loading into specific types of system memory using application binary interface (ABI)-compliant notes, according to various aspects of the present disclosure.

FIG. 5 is a process flow diagram illustrating a method for loading an executable image, according to various aspects of the present disclosure.

FIG. 6 is a block diagram showing an exemplary wireless communications system in which aspects of the disclosure may be advantageously employed.

FIG. 7 is a block diagram illustrating a design workstation used for circuit, layout, and logic design of a semiconductor component, such as the executable and linkable format (ELF) file for loading executables into specific types of system memory.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form to avoid obscuring such concepts.

As described herein, the use of the term “and/or” is intended to represent an “inclusive OR,” and the use of the term “or” is intended to represent an “exclusive OR.” As described herein, the term “exemplary” used throughout this description means “serving as an example, instance, or illustration,” and should not necessarily be construed as preferred or advantageous over other exemplary configurations. As described herein, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described herein, the term “proximate” used throughout this description means “adjacent, very near, next to, or close to.” As described herein, the term “on” used throughout this description means “directly on” in some configurations, and “indirectly on” in other configurations. It will be understood that the term “layer” includes film and is not construed as indicating a vertical or horizontal thickness unless otherwise stated. As described, the term “substrate” may refer to a substrate of a diced wafer or may refer to a substrate of a wafer that is not diced. Similarly, the terms “chip” and “die” may be used interchangeably.

Safety-related systems may be subjected to more stringent electrical operational specifications. This is because errors in such safety-related systems may result in severe injury or death to humans. For example, errors in vehicle or automotive control systems may result in severe injury or death to humans occupying associated vehicles, as well as humans, animals, and property that may collide with such vehicles. Such stringent electrical operational requirements may address system redundancy, greater resistance to electrical and software faults, and improved monitoring of such systems, to name a few issues. Additionally, these stringent electrical operational requirements may involve safety island (SAIL) subcomponents, such as low power island modes.

In practice, system applications supporting the noted low power island modes specify loading portions of an executable image into specific types of physical memory due to their power-saving characteristics. These executable images may be generated according to the executable and linkable format (ELF) standard binary file format supported on many different operating systems and platforms.

Executable images in ELF files include a memory map that outlines how the executable is loaded into a virtual address space. In practice, this metadata is utilized by a runtime ELF loader to read and map individual segments into memory before execution. Unfortunately, ELF metadata often falls short in specifying the physical memory placement of these segments. For example, runtime ELF loaders may use dynamic memory allocation to reserve and allocate physical memory. Moreover, setting up a fixed physical memory layout is not always practical.

Conversely, each subsystem of a system application that supports the noted low power island modes may use multiple island memory types and modes, necessitating the strategic division and placement of the executable into the appropriate memory type. Occasionally, a segment may be suitable for more than one type of memory, depending on availability and priority. The ELF format program table is insufficient for conveying memory type information to the runtime loader. Additionally, constructing ELF executables for fixed physical locations is not always ideal or feasible. A technique for loading executables into specific types of system memory using application binary interface (ABI)-compliant notes, is desired.

Various aspects of the present disclosure are directed to a technique for loading executable and linkable format (ELF) files representing an executable image in specific types of system memory using application binary interface (ABI)-compliant notes. In some implementations, text and data sections of the ELF file that map to the same type of memory are grouped into ELF segments using a linker script. Additionally, ABI-compliant notes are embedded into the ELF file for encoding a mapping scheme and specifying the types of memory to which each segment is mapped.

During operation, a runtime loader discovers these notes, decodes them, and uses the information to map the ELF segments to the appropriate memory type. This approach beneficially allows mapping of an ELF file representing an executable image (ELF file executable) to multiple types of physical memory. The ELF file executable does not specify linking to specific physical addresses, which provides greater flexibility. Additionally, each ELF segment can have multiple options for destination memory types. Accordingly, various aspects of the present disclosure leverage the existing ELF file executable format in an ABI-compliant manner, such that position-independent executable images may also utilize this scheme.

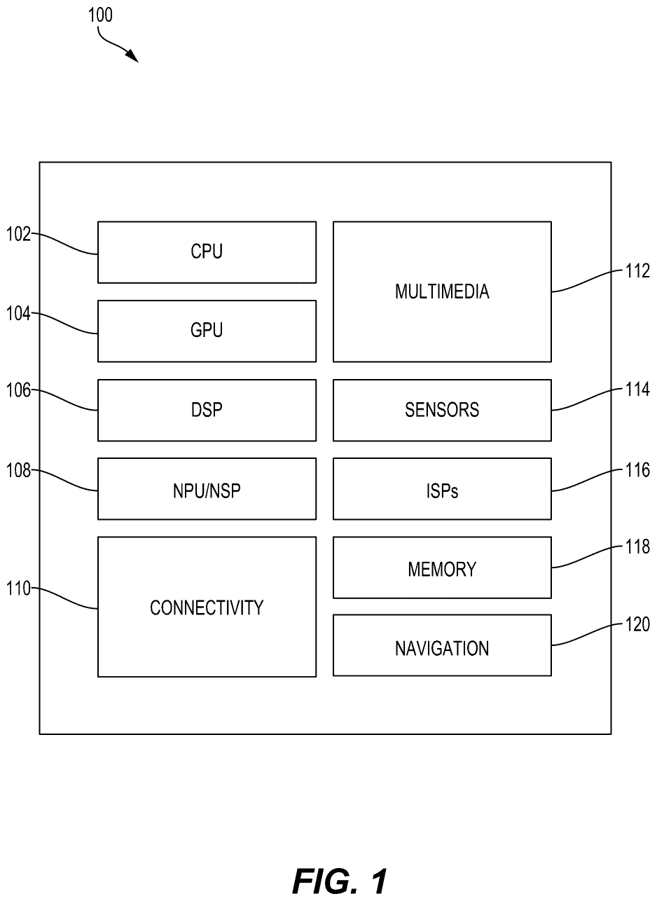

FIG. 1 illustrates an example implementation of a host system-on-chip (SoC) 100, which is configured to support low power island modes, in accordance with aspects of the present disclosure. The host SoC 100 includes processing blocks tailored to specific functions, such as a connectivity block 110. The connectivity block 110 may include sixth generation (6G), connectivity fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU)/neural signal processor (NSP) 108. The host SoC 100 may also include a sensor processor 114, image signal processors (ISPs) 116, a navigation module 120, which may include a global positioning system, and a memory 118. The multi-core CPU 102, the GPU 104, the DSP 106, the NPU/NSP 108, and the multimedia engine 112 support various functions such as video, audio, graphics, gaming, artificial networks, and the like. Each processor core of the multi-core CPU 102 may be an RISC-V machine, an advanced RISC machine (ARM), a microprocessor, or some other type of processor. The NPU/NSP 108 may be based on an ARM instruction set.

The multi-core CPU 102 is equipped with multiple cores. The number of cores in the multi-core CPU 102 may range from eight (8) processor cores in a mobile processor implementation to ninety-six (96) processor cores in a server compute platform implementation of the host SoC 100. Execution of real-world applications using the multi-core CPU 102 involves larger and more complex processor cores. Instructions added to the multi-core CPU 102 increase a size, complexity, and power dissipation of the multi-core CPU 102.

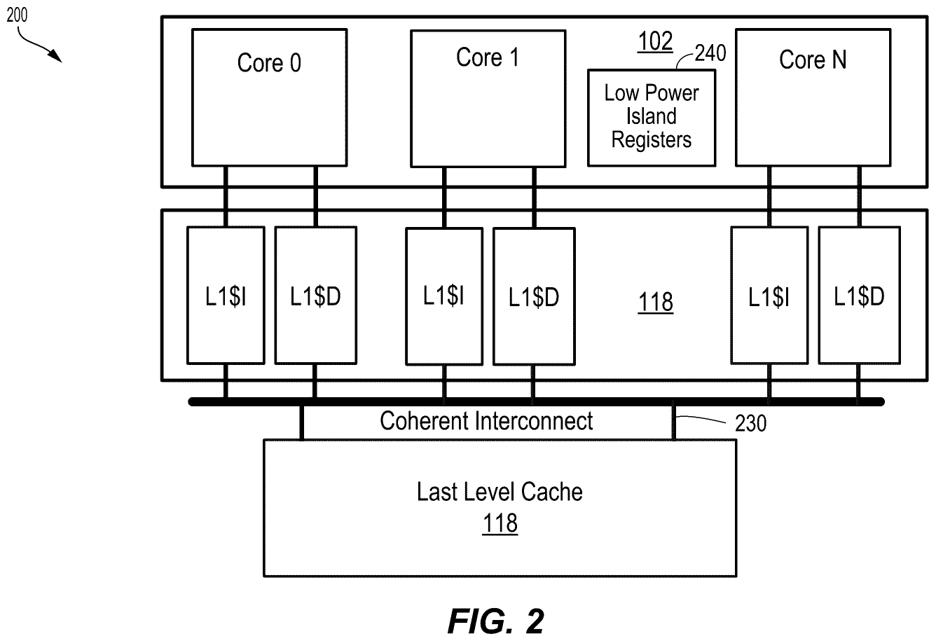

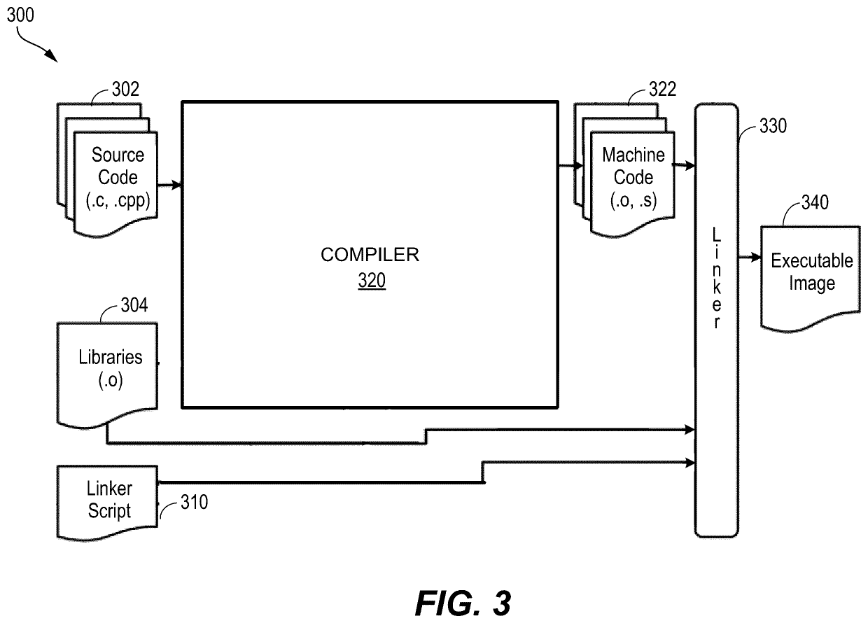

FIG. 2 is a circuit diagram further illustrating the system-on-chip (SoC) 100 of FIG. 1, including low power island registers 240 to support low power island modes, according to various aspects of the present disclosure. As shown in FIG. 2, an SoC 200 includes access to the memory 118 (e.g., level-one (L1) cache and/or last level cache (LLC)) through a coherent interconnect 230. In various aspects of the present disclosure, the SoC 200 is configured with the low power island registers 240 to support low power island modes of processor cores (e.g., Core 0, Core 1, . . . , Core N). In operation, the processor cores are configured to execute executable and linkable format (ELF) files representing an executable image generated, for example, as further illustrated in FIG. 3.

FIG. 3 is a block diagram illustrating a compiler and linker process 300 to support loading of executables into specific types of system memory using an application binary interface (ABI) format for ABI-compliant notes, according to various aspects of the present disclosure.

As shown in FIG. 3, the compiler and linker process 300 illustrates a compiler 320 to compile received source code 302 and generate machine code 322. In this example, the compiler 320 first receives the source code 302 of a program. As shown, the source code 302 has example file extensions .c and .cpp (indicating source code written in C or C++, respectively), but source code may be received in other languages, or may be in a human-readable assembly language. The compiler 320 initially compiles the source code 302 into a compiler-specific and platform independent intermediate representation (IR), designated with a .bc (bit code) file extension, and a platform-specific object code (designated with a .o file extension). Subsequently, the IR and platform-specific object code are further processed by the compiler 320 to generate the machine code 322.

Additionally, a linker 330 links the machine code 322 and libraries 304 as directed by a linker script 310 to build a final executable image 340. The linker script 310 is a utility that operates in conjunction with the linker 330, often in embedded application environments. In practice, the linker script 310 is utilized to express a fine degree of control over the final executable image 340. In particular, the linker script 310 is utilized to specify the particular sections of the final executable image 340 produced during the compilation process. The blocks illustrated in FIG. 3 may be implemented in software, hardware, firmware, or a combination of hardware, software, and firmware.

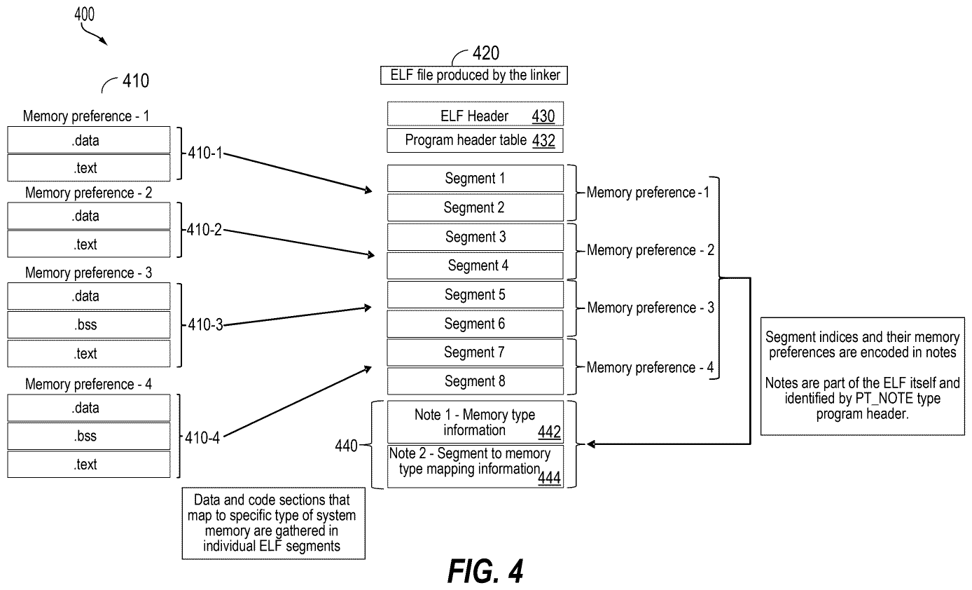

For example, the linker script 310 enables a user (e.g., a developer) to explicitly describe the memory layout of the executable image produced by the linker 330. This is a facility often used for embedded applications where users want to exert a fine degree of control in order to support techniques such as compression, tightly coupled memory (TCM) placement, and dynamic heap reclamation that are applied to some, but not all, or the input data and code (historically called “text”). The order of input files (e.g., .c and .cpp files) can also affect the linking process, in addition to the impact of the linker script 310 on the linking process. The systems and methods of the present disclosure ensure that the final executable image 340 supports loading into specific types of system memory using application binary interface (ABI)-compliant notes, for example, as shown in FIG. 4.

FIG. 4 is a block diagram illustrating an executable and linkable format (ELF) file to support loading into specific types of system memory using application binary interface (ABI)-compliant notes, according to various aspects of the present disclosure. As shown in FIG. 4, an output format 400 of a final executable image 420 is generated as an ELF file, for example, utilizing the linker 330 of FIG. 3. Various aspects of the present disclosure leverage the existing ELF file executable format in an ABI-compliant manner, such that position-independent executable images may also utilize this scheme.

In this implementation, formation of the final executable image 420 involves specifying memory preferences 410 (410-1, 410-2, 410-3, 410-4). For example, the predefined memory preferences may include a combination of a .text section for executable code, a .data section for memory objects, and a .bss section for uninitialized objects. For example, the first memory preference 410-1 and the second memory preference 410-2 each include a .text section and a .data section. Additionally, the third memory preference 410-3 and the fourth memory preference 410-4 each include a .data section, a .bss section, and a .text section.

According to various aspects of the present disclosure, data and code sections that map to a specific type of system memory are gathered in individual ELF segments. As shown in FIG. 4, data and code sections that map to the same type of memory preference are grouped into ELF segments of the final executable image 420 using a linker script (e.g., the linker script 310). For example, the final executable image 420, as represented as an ELF file (e.g., produced by the linker 330 of FIG. 3), groups various segments according to a memory preference. In this example, segment one (S1) and segment two (S2) are grouped according to the first memory preference 410-1. Similarly, segment three (S3) and segment four (S4) are grouped according to the second memory preference 410-2. Additionally, segment five (S5) and segment six (S6) are grouped according to the third memory preference 410-3. Finally, segment seven (S7) and segment eight (S8) are grouped according to the fourth memory preference 410-4.

As shown in FIG. 4, the ELF file representing the final executable image 420 includes an ELF header 430, having a program header table 432 to identify a notes section 440 of the ELF file. According to various aspects of the present disclosure, the notes section 440 is ABI-compliant and embedded into the ELF file for encoding the memory type information section in note one (1) 442 and a segment to memory type mapping information in note two (2) 444. In this implementation, segment indices and their memory preferences are encoded in the notes section 440. Additionally, the notes section 440, which is a defined portion of the ELF file, is identified using, for example, a notes type (e.g., a PT_NOTE type) in the program header table 432 of the ELF header 430.

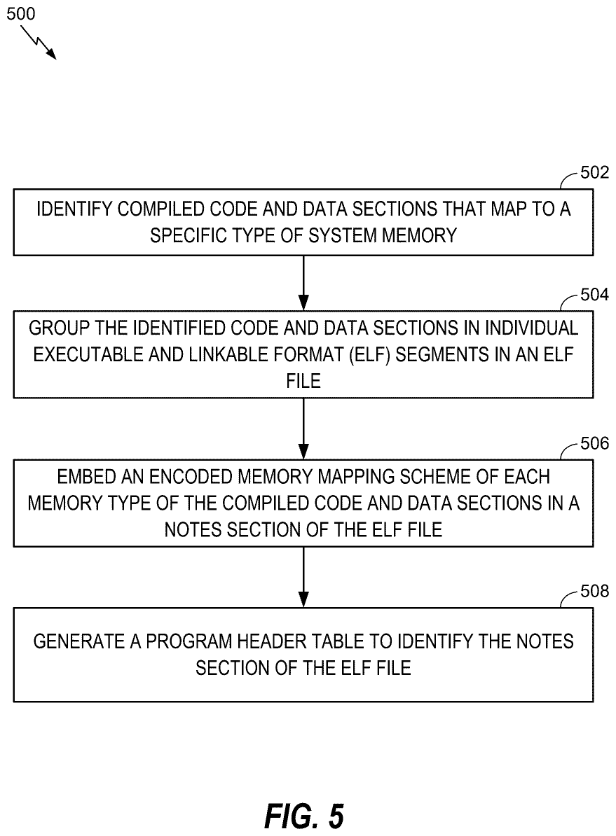

During operation, a runtime loader discovers the notes section 440, decodes the notes section 440, and uses the information to map the ELF segments of the final executable image 420 to the appropriate memory type. This approach beneficially supports an encoded memory mapping scheme of an ELF file representing the final executable image 420 (e.g., an ELF executable) to multiple types of physical memory. The ELF executable does not specify linking to specific physical addresses, which provides greater flexibility. Additionally, each ELF segment can have multiple options for destination memory types. Accordingly various aspects of the present disclosure leverage the existing ELF file executable format in an ABI-compliant manner, such that position-independent executable images may also utilize this scheme. A process for loading an executable into specific types of system memory is illustrated, for example, in FIG. 5.

FIG. 5 is a process flow diagram illustrating a method 500 for loading an executable image, according to various aspects of the present disclosure. The method 500 begins at block 502, in which compiled code and data sections that map to a specific type of system memory are identified. For example, as shown in FIG. 4, formation of the final executable image 420 involves specifying memory preferences 410 (410-1, 410-2, 410-3, 410-4). For example, the predefined memory preferences may include a combination of a .text section for executable code, a .data section for memory objects, and a .bss section for uninitialized objects. For example, the first memory preference 410-1 and the second memory preference 410-2 each include a .text section and a .data section. Additionally, the third memory preference 410-3 and the fourth memory preference 410-4 each include a .data section, a .bss section, and a .text section.

At block 504, the identified code and data sections are grouped in individual executable and linkable format (ELF) segments in an ELF file. For example, as shown in FIG. 4, data and code sections that map to a specific type of system memory are gathered in individual ELF segments. In this example, segment one (S1) and segment two (S2) are grouped according to the first memory preference 410-1. Similarly, segment three (S3) and segment four (S4) are grouped according to the second memory preference 410-2. Additionally, segment five (S5) and segment six (S6) are grouped according to the third memory preference 410-3. Finally, segment seven (S7) and segment eight (S8) are grouped according to the fourth memory preference 410-4.

At block 506, an encoded memory mapping scheme of each memory type of the compiled code and data sections is embedded in a notes section of the ELF file. For example, as shown in FIG. 4, the notes section 440 is ABI-compliant and embedded into the ELF file for encoding the memory type information section in note one (1) 442 and a segment to memory type mapping information in note two (2) 444. In this implementation, segment indices and their memory preferences are encoded in the notes section 440.

At block 508, a program header table is generated to identify the notes section of the ELF file. For example, as shown in FIG. 4, the ELF file representing the final executable image 420 includes an ELF header 430, having a program header table 432 to identify a notes section 440 of the ELF file. As shown in FIG. 4, the notes section 440, which is a defined portion of the ELF file, is identified using, for example, a notes type (e.g., a PT_NOTE type) in the program header table 432 of the ELF header 430.

In some aspects, the method 500 may be performed by the host SoC 100 (FIG. 1). That is, each of the elements of the method 500 may, for example, but without limitation, be performed by the host SoC 100 or one or more processors (e.g., the multi-core CPU 102 and/or the NPU 130) and/or other components included therein.

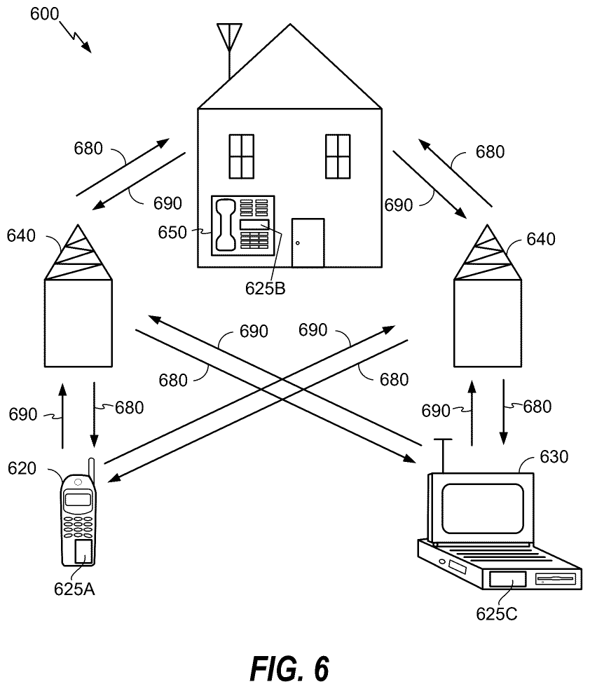

FIG. 6 is a block diagram showing an exemplary wireless communications system 600 in which an aspect of the disclosure may be advantageously employed. For purposes of illustration, FIG. 6 shows three remote units 620, 630, and 650, and two base stations 640. It will be recognized that wireless communications systems may have many more remote units and base stations. Remote units 620, 630, and 650 include IC devices 625A, 625B, and 625C that include the disclosed executable and linkable format (ELF) file for loading executables into specific types of system memory. It will be recognized that other devices may also include the disclosed ELF, such as the base stations, switching devices, and network equipment. FIG. 6 shows forward link signals 680 from the base stations 640 to the remote units 620, 630, and 650, and reverse link signals 690 from the remote units 620, 630, and 650 to base stations 640.

In FIG. 6, remote unit 620 is shown as a mobile telephone, remote unit 630 is shown as a portable computer, and remote unit 650 is shown as a fixed location remote unit in a wireless local loop system. For example, the remote units may be a mobile phone, a hand-held personal communications systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 6 illustrates remote units according to aspects of the present disclosure, the disclosure is not limited to these exemplary illustrated units. Aspects of the present disclosure may be suitably employed in many devices, which include the disclosed ELF file for loading executables into specific types of system memory.

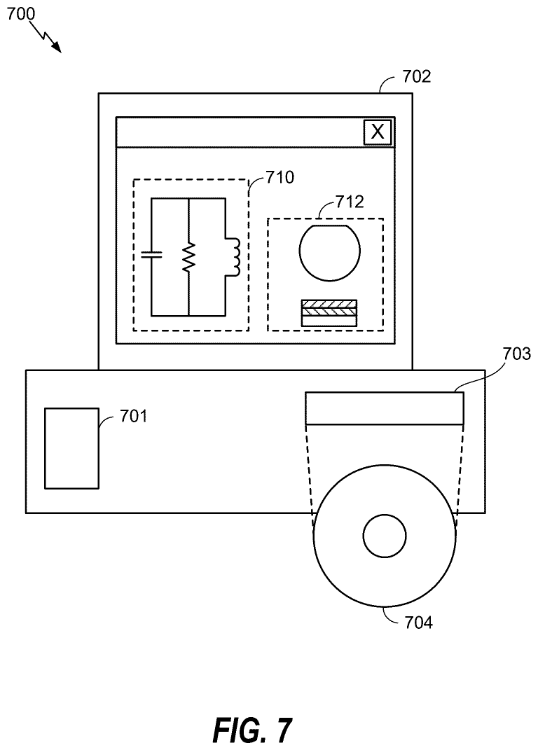

FIG. 7 is a block diagram illustrating a design workstation used for circuit, layout, and logic design of a semiconductor component, such as the executable and linkable format (ELF) file for loading executables into specific types of system memory disclosed above. A design workstation 700 includes a hard disk 701 containing operating system software, support files, and design software such as Cadence or OrCAD. The design workstation 700 also includes a display 702 to facilitate design of a circuit 710 or an integrated circuit (IC) component 712 such as the ELF file. A storage medium 704 is provided for tangibly storing the design of the circuit 710 or the IC component 712 (e.g., the ELF file for loading executables into specific types of system memory). The design of the circuit 710 or the IC component 712 may be stored on the storage medium 704 in a file format such as GDSII or GERBER. The storage medium 704 may be a CD-ROM, DVD, hard disk, flash memory, or other appropriate device. Furthermore, the design workstation 700 includes a drive apparatus 703 for accepting input from or writing output to the storage medium 704.

Data recorded on the storage medium 704 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 704 facilitates the design of the circuit 710 or the IC component 712 by decreasing the number of processes for designing semiconductor wafers.

Implementation examples are described in the following numbered clauses:

1. A method for loading an executable, the method comprising:
identifying compiled code and data sections that map to a specific type of system memory;
grouping the identified code and data sections in individual executable and linkable format (ELF) segments in an ELF file;
embedding an encoded memory mapping scheme of each memory type of the compiled code and data sections in a notes section of the ELF file; and
generating a program header table to identify the notes section of the ELF file.

2. The method of clause 1, in which the notes section of the ELF file comprises a memory type information section and the encoded memory mapping scheme.

3. The method of any of clauses 1 or 2, in which grouping comprises storing, by a linker script, the compiled code and data sections grouped in the individual ELF segments in the ELF file.

4. The method of any of clauses 1-3, in which the notes section comprises an application binary interface (ABI) format.

5. The method of any of clauses 1-4, further comprising outputting a final executable image according to the ELF file.

6. The method of any of clauses 1-5, in which generating the program header table comprises specifying a notes type to identify the notes section of the ELF file.

7. The method of any of clauses 1-6, further comprising specifying memory preferences to define the memory mapping scheme.

8. The method of clause 7, in which the memory preferences include a combination of a .text section for executable code, a .data section for memory objects, and a .bss section for uninitialized objects.

9. The method of any of clauses 1-8, in which the compiled code is generated from source code of a system application to support low power island modes.

10. A non-transitory computer-readable medium having program code recorded thereon for loading an executable, the program code being executed by a processor and comprising:
program code to identify compiled code and data sections that map to a specific type of system memory;
program code to group the identified code and data sections in individual executable and linkable format (ELF) segments in an ELF file;
program code to embed an encoded memory mapping scheme of each memory type of the compiled code and data sections in a notes section of the ELF file; and
program code to generate a program header table to identify the notes section of the ELF file.

11. The non-transitory computer-readable medium of clause 10, in which the notes section of the ELF file comprises a memory type information section and the encoded memory mapping scheme.

12. The non-transitory computer-readable medium of any of clauses 10 or 11, in which the program code to group comprises program code to store, by a linker script, the compiled code and data sections grouped in the individual ELF segments in the ELF file.

13. The non-transitory computer-readable medium of any of any of clauses 10-12, in which the notes section comprises an application binary interface (ABI) format.

14. The non-transitory computer-readable medium of any of clauses 10-13, further comprising program code to output a final executable image according to the ELF file.

15. The non-transitory computer-readable medium of any of clauses 10-14, in which the program code to generate the program header table comprises program code to specify a notes type to identify the notes section of the ELF file.

16. The non-transitory computer-readable medium of any of clauses 10-15, further comprising program code to specify memory preferences to define the memory mapping scheme.

17. The non-transitory computer-readable medium of clause 16, in which the memory preferences include a combination of a .text section for executable code, a .data section for memory objects, and a .bss section for uninitialized objects.

18. The non-transitory computer-readable medium of any of clauses 10-17, in which the compiled code is generated from source code of a system application to support low power island modes.

For a firmware and/or software implementation, the methodologies may be implemented with modules (e.g., procedures, functions, etc.) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a non-transitory computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer. Disk and disc, as used herein, include compact disc (CD), laser disc, optical disc, digital versatile disc (DVD), floppy disk and Blu-ray® disc, where disks usually reproduce data magnetically, while discs reproduce data optically with lasers. Combinations of the above should also be included within the scope of computer-readable media.

In addition to storage on a non-transitory computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, various changes, substitutions, and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present application is not intended to be limited to the configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform the same function or achieve the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for loading an executable, the method comprising:
identifying compiled code and data sections that map to a specific type of system memory;
grouping the identified code and data sections in individual executable and linkable format (ELF) segments in an ELF file;
embedding an encoded memory mapping scheme of each memory type of the compiled code and data sections in a notes section of the ELF file; and
generating a program header table to identify the notes section of the ELF file.

2. The method of claim 1, in which the notes section of the ELF file comprises a memory type information section and the encoded memory mapping scheme.

3. The method of claim 1, in which grouping comprises storing, by a linker script, the compiled code and data sections grouped in the individual ELF segments in the ELF file.

4. The method of claim 1, in which the notes section comprises an application binary interface (ABI) format.

5. The method of claim 1, further comprising outputting a final executable image according to the ELF file.

6. The method of claim 1, in which generating the program header table comprises specifying a notes type to identify the notes section of the ELF file.

7. The method of claim 1, further comprising specifying memory preferences to define the memory mapping scheme.

8. The method of claim 7, in which the memory preferences include a combination of a .text section for executable code, a .data section for memory objects, and a .bss section for uninitialized objects.

9. The method of claim 1, in which the compiled code is generated from source code of a system application to support low power island modes.

10. A non-transitory computer-readable medium having program code recorded thereon for loading an executable, the program code being executed by a processor and comprising:
program code to identify compiled code and data sections that map to a specific type of system memory;
program code to group the identified code and data sections in individual executable and linkable format (ELF) segments in an ELF file;
program code to embed an encoded memory mapping scheme of each memory type of the compiled code and data sections in a notes section of the ELF file; and
program code to generate a program header table to identify the notes section of the ELF file.

11. The non-transitory computer-readable medium of claim 10, in which the notes section of the ELF file comprises a memory type information section and the encoded memory mapping scheme.

12. The non-transitory computer-readable medium of claim 10, in which the program code to group comprises program code to store, by a linker script, the compiled code and data sections grouped in the individual ELF segments in the ELF file.

13. The non-transitory computer-readable medium of claim 10, in which the notes section comprises an application binary interface (ABI) format.

14. The non-transitory computer-readable medium of claim 10, further comprising program code to output a final executable image according to the ELF file.

15. The non-transitory computer-readable medium of claim 10, in which the program code to generate the program header table comprises program code to specify a notes type to identify the notes section of the ELF file.

16. The non-transitory computer-readable medium of claim 10, further comprising program code to specify memory preferences to define the memory mapping scheme.

17. The non-transitory computer-readable medium of claim 16, in which the memory preferences include a combination of a .text section for executable code, a .data section for memory objects, and a .bss section for uninitialized objects.

18. The non-transitory computer-readable medium of claim 10, in which the compiled code is generated from source code of a system application to support low power island modes.
